(19) United States
(12) Patent Application Publication
(10) Pub. No.: US 2022/0016552 A1
(43) Pub. Date: Jan. 20, 2022

(54) Slit spiral tube for self-cleaning pressure filters and a slot self-cleaning pressure filter with such a slit tube

(71) Applicant: Marek MANIA, Kielce (PL)

(72) Inventor: Marek MANIA, Kielce (PL)

(21) Appl. No.: 17/488,911

(22) Filed: Sep. 29, 2021

Related U.S. Application Data
(63) Continuation of application No. PCT/PL2020/000034, filed on Mar. 30, 2020.

(30) Foreign Application Priority Data
Apr. 1, 2019 (PL) P.429466

(51) Int. Cl. B01D 29/72; B01D 29/48; B01D 29/64; C02F 11/122

(52) U.S. Cl. CPC B01D 29/72; B01D 29/48; C02F 2303/16; C02F 11/122; B01D 29/6476

(57) ABSTRACT

The slit spiral tube for self-cleaning pressure filters in which the spiral element is mounted on supports, by maintaining the spiral circumferential slit wherein, in the spiral circumferential slit (s) there is a fixed working spiral moving back and forth. The slot self-cleaning pressure filter for dewatering liquid media consisting of a cylindrical casing in which there is a medium inflow, an effluent outflow and a sludge overflow and slit spiral tubes placed centrally, axially one in another, out of which each tube has a spiral element fixed on supports by maintaining the spiral circumferential slit, wherein, in the spiral circumferential slit (s) of both the external slit spiral tube and the internal slit spiral tube a working spiral moving back and forth is mounted, whereas, between the slit spiral tubes and a motor-driven spiral rotatable scraper is mounted.

This application is a continuation application of International Application PCT/PL2020/000034, filed Mar. 30, 2020 and designated the U.S., which claims priority to Polish Patent Application No. P.429466, filed Apr. 1, 2019, the contents of the aforementioned applications are incorporated herein by reference in their entirety.

The subject of certain embodiments herein is a slit spiral tube for self-cleaning pressure filters and a self-cleaning pressure filter with such a slit tube intended for purifying liquid media in a continuous cycle.

Slit filter devices with slit spiral tubes produced by such companies as PERFOPOL, PROGRESS ECO, NILTECH or PFTechnology are related art. Slit spiral tubes in such filter devices consist of vertical, circumferentially arranged supports on which spiral elements are wound in the form of coils of profiled wire. The spiral elements are permanently mounted directly on vertical supports by maintaining the spiral slit between coils.

The slotted sieve known from the Polish patent description No. 187899, in which the inter-slit partition is comprised of dimensionally decreasing elements situated one on top of another in the flow direction of the fluidized factor and the inter-slit gap constitutes the stretchable flat spiral with adjacent coils, whereby, the ends of the spiral are mounted to parallel bases.

Another slotted sieve known from the Polish patent description No. 189942 with holes in the shape of slits which originated between the adjacent profiled bars of a specific shape mounted on supports has slits which are tilted from the perpendicular by an a angle and the width ratio of the slit to the width of the face of the profiled bar is contained in the range from 0.04 to 0.3.

Another self-cleaning pressure filter known from the Polish patent description No. 198799 contains a casing with an inflow ferrule of purified liquid and the outflow ferrule of purified liquid and a cylindrical filter cartridge placed between them inside of which in the center there is a purifying unit performing a circular motion, which is equipped with at least two suction nozzles, spaced on two planes perpendicular to its axis and at opposite sides of the filter cartridge, whereas, the purifying device consists of a tube collector and suction nozzles with sleeves and connectors, mounted on it in an alternating way, whereas the tube collector is fitted outside with fixed limiters and holes, distributed in such a way and of a size corresponding to the distribution and the size of clearances, in the perpedicular cross section of the connectors which are displaced, in regard to other suction nozzles, by an angle which covers at least the holes preceding them, while the sleeves have locks at the ends which cooperate with the limiters.

The wastewater filtration unit is known from disclosure No. W02018031884. The filter unit contains a drum filter which consists of a rotatable drum with the surface of the filter whose first side is directed to the inside of the drum and whose second side is directed to the outside of the rotatable drum and which is smoothly connected with the source of sewage and a disc filter with an inflow smoothly connected with the first side of the surface of the rotatable drum filter. Some construction examples show that the disc filter contains a lot of disc-shaped filter elements fixed to the central drum which are configured to receive filtered sewage running through the surface of the drum filter and to filter the filtered sewage. In one construction example the disc filter inlet is smoothly connected with interior of the central drum of the disc filter. In another construction example the rotable drum of the drum filter and the central drum of the disc filter are placed along the common longitudinal axis. In some construction examples the rotable drum of the drum filter is connected with the central drum of the disc filter. According to another construction example, the disc filter moreover contains a casing which at least partially encloses the drum filter and the disc filter, whereby, the casing has an inlet spout smoothly connected with sewage and the other side of the filter surface of the rotable drum filter, an outlet spout smoothly connected with the filtrate and a sealing plate configured for separating the inlet trough from the outlet spout. In some construction examples the disc filter contains moreover a gutter with a drum filter smoothly connected with the external part of the rotatable drum. In some construction examples the disc filter contains moreover a backwashing system.

### FIGURES

FIG. 1 construction examples where FIG. 1 schematically presents a self-cleaning pressure filter with slit spiral tubes shown in FIG. 2 and FIG. 3;

FIG. 2 construction example of slit spiral tube for self-cleaning pressure filters;

FIG. 3 schematically presents a section of the slit spiral tube in accordance with certain embodiments herein with the spiral circumferential slit placed on the outside of the slit spiral tube.

Pursuant to the advantageous construction examples of certain embodiments herein, a filter system is thus provided which is suited for cleaning, containing a casing which designates the inlet of the liquid to be filtered and the outlet for the filtered liquid, a stack of filter discs placed in the casing and determining the upper surface of the connection with the inlet and the lower surface communicating itself with the purifying device with an outlet and a filter containing a lot of nozzles connected with the source of the backwashing liquid and ensuring a stream of liquid under high pressure, striking the lower surface and the device for assuring the movement of numerous nozzles in relation to the lower surface which results in the same systematic scanning of generally all filter discs. Advantageously, the stack of filter discs contains generally a cylindrical stack of ring-shaped discs, whereby, the upper surface is determined by the external cylindrical surface of the stack and the lower surface is determined by the interior cylindrical surface of the stack. The filter system known from the American patent description U.S. Pat. No. 5,228,993 contains filter discs which can be cleaned by backwashing.

Pursuant to the advantageous construction examples, of certain embodiments herein a filter system is thus ensured suited for cleaning, containing a casing designating the inlet of the liquid to be filtered and the outlet for the filtered liquid, a stack of filter discs placed in the casing and determining the upper surface of the connection with the inlet and the lower surface communicating itself with the purifying device with an outlet and a filter containing numerous nozzles connected with the source of the backwashing liquid and ensuring a stream of liquid under high pressure striking the lower surface and the device for assuring the movement of numerous nozzles in relation to the lower surface. Advantageously, the stack of filter discs contains generally a cylindrical stack of ring-shaped discs, whereby, the upper surface is determined by the external cylindrical surface of the stack and the lower surface is determined by the interior cylindrical surface of the stack. Pursuant to the alternative construction examples of certain embodiments herein , each of the numerous nozzles determines an elongated outlet of the nozzle stretching along many discs. One of multiple goals is to improve the effectiveness of cleaning the slits in slit tubes in the course of operation and thus to increase the effectiveness of purifying the inflowing medium. The slit spiral tube for self-cleaning pressure filters in which the spiral element is mounted on supports and the spiral circumferential slit is situated between its coils, in accordance with certain embodiments herein, is characterized by the fact that in the spiral circumferential slit there is an installed movable working spiral moving back and forth. In the first version the slit spiral tube is also characterized by the fact that the spiral circumferential slit and the movable working spiral are placed on the inside of the slit spiral tube, however, in the second version the spiral circumferential slit and the movable working spiral are placed on the outside of the slit spiral tube. Advantageously, the working spiral has a flat structure of a thickness below the height of the spiral circumferential slit. The slot self-cleaning pressure filter for dewatering liquid media, built of a cylindrical casing in which there is a medium inflow, an effluent outflow and a sludge overflow and which contains slit spiral tubes placed centrally axially one inside the other, out of which each tube has a spiral element fixed on the supports, whereas, the spiral circumferential slit is placed between the coils of the spiral element and according to certain embodiments herein is characterized by the fact that in the spiral circumferential slit of each of the slit spiral tubes, a movable working spiral is fitted which moves back and forth, whereas between the slit spiral tubes there is a mounted motor-driven spiral rotatable scraper. The filter is also characterized by the fact that the slit spiral tube of a larger diameter has a spiral circumferential slit and a movable working spiral facing away from the inflowing medium from the inside of the tube, whereas, the slit spiral tube of a smaller diameter has a spiral circumferential slit and a movable working spiral facing towards the inflowing medium from the outside of the tube. The width of the spiral rotatable scraper corresponds to the distance between the slit spiral tubes. The drain outflow has a control valve.

The slit spiral tubes, according to certain embodiments herein, may be used in numerous structures of self-cleaning filters intended for dewatering liquid media, including multitubular ones. The advantage of the filter, according to certain embodiments herein, is an uncomplicated structure of the self-cleaning unit in the continuous filtering process, maintaining a constant flow parameter of the purified liquid medium and a high sediment filtrating capacity.

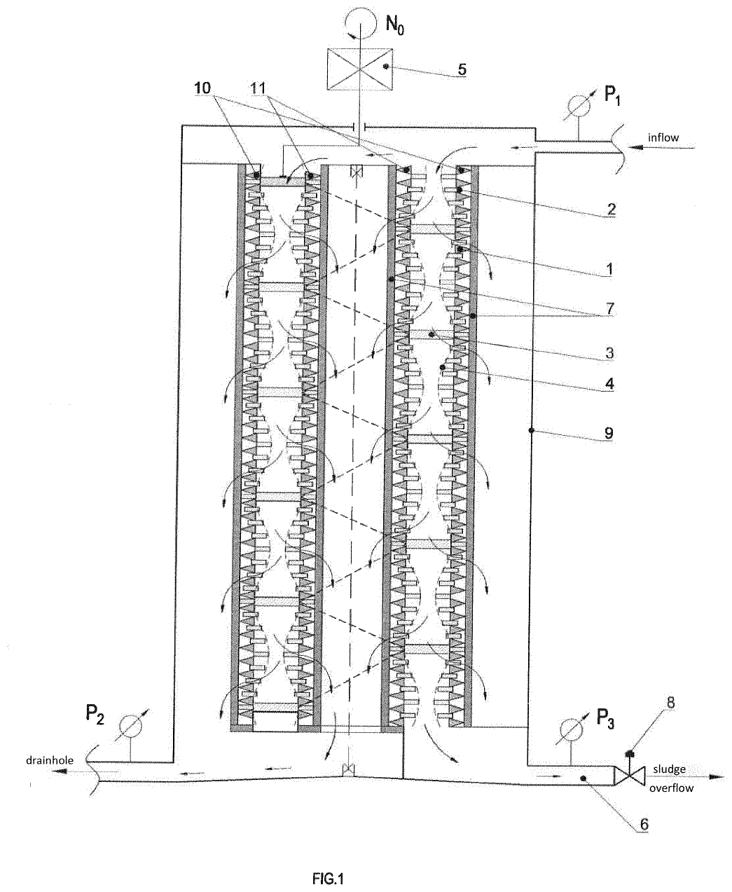

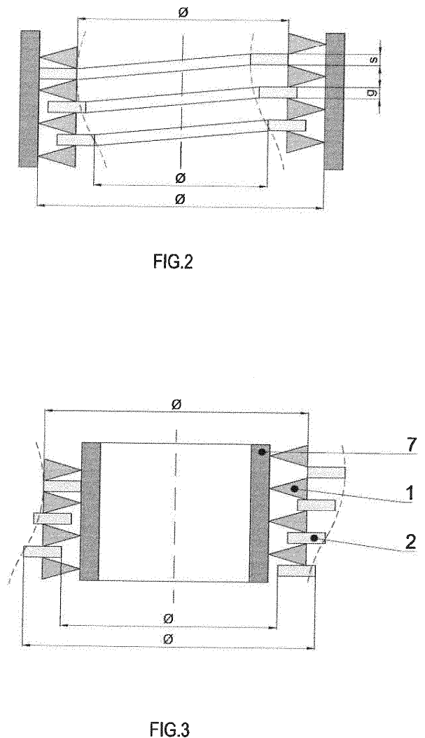

The subject of certain embodiments herein is presented in the construction examples in the diagram where FIG. 1 schematically presents a self-cleaning pressure filter with slit spiral tubes shown in FIG. 2 and FIG. 3, FIG. 2 schematically presents a section of the slit spiral tube in the first version in accordance with certain embodiments herein, with the spiral circumferential slit positioned on the inside of the slit spiral tube, whereas, FIG. 3 schematically presents a section of the slit spiral tube in the second version in accordance with certain embodiments herein with the spiral circumferential slit placed on the outside of the slit spiral tube.

The slit spiral tube for self-cleaning pressure filters in the first construction example shown in FIG. 2 has a spiral element 1 fixed on supports 7 by maintaining the spiral circumferential slit “s”. The spiral element 1 is placed on the inside of the slit spiral tube. In the spiral slit “s” between the coils of the spiral element 1 , the slit tube has a mounted movable working spiral 2 of a flat structure moving back and forth. Thickness “g” of the movable working spiral 2 is smaller than the height of the spiral circumferential slit “s”. The slit spiral tube for self-cleaning pressure filters in the second construction example shown in FIG. 3 has a spiral element 1 fixed on supports 7, by maintaining the spiral circumferential slit “s”. The spiral element 1 is placed on the outside of the slit spiral tube. In the spiral circumferential slit “s” positioned between the coils of the spiral element 1, the slit spiral tube has a mounted movable working spiral 2 of a flat structure moving back and forth. Thickness “g” of the movable working spiral 2 is smaller than the height of the spiral circumferential slit “s”. The further part of the description presents an example of the slot self-cleaning filter into which slit spiral tubes with a structure as in example 1 and 2 were mounted. The slot self-cleaning pressure filter for dewatering liquid media in the construction example shown in FIG. 1 consists of a cylindrical casing 9 in which there is a medium inflow, an effluent outflow and a sludge overflow and it also has two slit spiral tubes placed in it centrally and axially with a spiral circumferential slit “s”, out of which one is an external tube 10 and the second one an internal tube 11. The external slit spiral tube 10 has a spiral element 1 mounted on supports 7, whereby, between the coils of the spiral element 1 there is a spiral circumferential slit “s”. The spiral element 1 is positioned on the inside of the slit spiral tube 10. A movable working spiral 2 of a flat structure moving back and forth is mounted in the spiral slit s″ between the coils of the spiral element 1. Thickness “g” of the movable working spiral 2 is smaller than the height of the spiral circumferential slit “s”. The internal slit spiral tube 11 has a spiral element 1 fixed on supports 7 by maintaining the spiral circumferential slit “s”. The spiral element 1 is placed on the outside of the slit spiral tube 11. In the spiral slit “s” between the coils of the spiral element 1 there is a movable working spiral 2 of a flat structure moving back and forth. Thickness “g” of the movable working spiral 2 is smaller than the height of the spiral circumferential slit “s”. In the external slit tube 10 and in the internal slit tube 11, the spiral slits s″ together with movable working spirals 2 are positioned from the side of the media inflow and between the external slit tube 10 and the internal slit tube 11 there is a spiral rotatable scraper 3, imposing a back and forth motion to both movable working spirals 2. The spiral rotatable scraper is connected with the motor 5. The width of the spiral rotatable scraper 3 corresponds to the distance between the external slit spiral tube 10 and the internal slit spiral tube 11. The sludge overflow 6 has a control valve 8.

The liquid medium is filtered, in the depicted structure, in such a way that the liquid medium flows between the slit spiral tubes, i.e. the external tube 10 and internal tubell under controlled pressure and is filtered on slits “s” leaking outside the slit spiral tube 10 of a greater diameter and inside the slit spiral tube 11 of a smaller diameter. The accumulated sludge on the slitted holes “s” is pushed through the space between slit spiral tubes 10 and 11 thanks to movable working spirals 2 which are moved back and forth in the slits s″ when submitted to rotational stress of the spiral scraper 3. The concentrated sludge is pushed down to their lower parts via the spiral rotatable scraper 3. The filtered liquid flows down through a drainhole and the sludge overflows through a sludge overflow 6.

Aspect 1. A slit spiral tube for self-cleaning pressure filters in which the spiral element is mounted on supports, forming a spiral circumferential slit, is characterized in that there is a movable working spiral (2) moving back and forth in the spiral circumferential slit (s).

Aspect 2. The slit tube pursuant to Aspect 1 is characterized in that the spiral circumferential slit (s) and the movable working spiral (2) are placed on the inside of the slit spiral tube.

Aspect 3. The slit tube pursuant to Aspect 1 is characterized in that the spiral circumferential slit (s) and the movable working spiral (2) are placed on the outside of the slit spiral tube.

Aspect 4. The slit tube pursuant to Aspect 1 is characterized in that the movable working spiral (2) has a flat structure with a thickness (g) below the height of the spiral circumferential slit (s).

Aspect 5. The slot self-cleaning pressure filter for dewatering liquid media which consists of a cylindrical casing containing a medium inflow, an effluent outflow and a sludge overflow and slit spiral tubes placed centrally and axially one in another, is characterized in that it contains slit spiral tubes pursuant to Aspect 1, whereas, a motor-driven (5) spiral rotatable scraper (3) is mounted between the external slit spiral tube (10) and the internal slit spiral tube (11).

Aspect 6. The filter pursuant to Aspect 5 is characterized in that the external slit spiral tube (10) has a spiral circumferential slit (s) and a movable working spiral facing away from the inflowing medium from the inside of the tube (10).

Aspect 7. The filter pursuant to Aspect 5 is characterized in that the internal slit spiral tube (11) has a spiral circumferential slit (s) and a movable working spiral (2) facing the inflowing medium from the outside of the pipe (11).

Aspect 8.The filter pursuant to Aspect 5 is characterized in that the width of the spiral rotatable scraper (3) corresponds to the distance between the external slit spiral tube (10) and the internal slit spiral tube (11).

Aspect 9. The filter pursuant to Aspect 5 is characterized in that the sludge overflow (6) has a control valve (8).

What is claimed is:

1. A slit spiral tube for self-cleaning pressure filters in which a spiral element is mounted on supports, forming a spiral circumferential slit, comprising:
a movable working spiral configured to move back and forth in the spiral circumferential slit (s).

2. The slit tube of claim 1, wherein the spiral circumferential slit (s) and the movable working spiral are placed on the inside of the slit spiral tube.

3. The slit tube of claim 1, wherein the spiral circumferential slit (s) and the movable working spiral are placed on the outside of the slit spiral tube.

4. The slit tube of claim 1, wherein the movable working spiral has a flat structure with a thickness (g) below the height of the spiral circumferential slit (s).

5. A slot self-cleaning pressure filter for dewatering liquid media comprising a cylindrical casing containing a medium inflow, an effluent outflow and a sludge overflow and slit spiral tubes placed centrally and axially one in another, wherein the slot self-cleaning pressure filter contains slit spiral tubes in which a spiral element is mounted on supports, forming a spiral circumferential slit, including a movable working spiral configured to move back and forth in the spiral circumferential slit (s), whereas, a motor-driven spiral rotatable scraper is mounted between the external slit spiral tube and the internal slit spiral tube.

6. The filter of claim 5, wherein the external slit spiral tube has a spiral circumferential slit (s) and a movable working spiral facing away from the inflowing medium from the inside of the tube.

7. The filter of claim 5, wherein the internal slit spiral tube has a spiral circumferential slit (s) and a movable working spiral facing the inflowing medium from the outside of the pipe.

8. The filter of claim 5, wherein the width of the spiral rotatable scraper corresponds to the distance between the external slit spiral tube and the internal slit spiral tube.

9. The filter of claim 5, wherein the sludge overflow has a control valve.
